(19) United States
(12) Patent Application Publication
(10) Pub. No.: US 2025/0249551 A1
(43) Pub. Date: Aug. 7, 2025

(54) FIXING SYSTEM

(71) Applicant: TECHNOLOGIES CGC INC., Quebec (CA)

(72) Inventors: Carl BOUCHARD, Quebec (CA); Bruno DESAULNIERS, Quebec (CA)

(21) Appl. No.: 18/854,171

(22) PCT Filed: Apr. 4, 2023
(86) PCT No.: PCT/CA2023/050453

§ 371 Date: Oct. 4, 2024

Related U.S. Application Data
(60) Provisional application No. 63/327,000, filed on Apr. 4, 2022.

(51) Int. Cl. B25B 5/10; A61G 13/10; B25B 5/16

(52) U.S. Cl. CPC B25B 5/101; A61G 13/101; B25B 5/166

(57) ABSTRACT

A fixing system has first and second jaw portions and a resilient member. The first jaw portion has a body defining a channel having an internal threaded portion, a mounting interface, and a first jaw. The second jaw portion has a handle component, a second jaw connected to the handle component, a rod connected to the second jaw and selectively moveable between actuated and non-actuated positions and biased toward the non-actuated position by the resilient member, and a connector pivotably connected to the handle component and having an engaging portion. The handle component is received in the channel, and defines a handle channel in which the rod is received. The engaging portion is moveable between disengaged and engaged positions, in which the engaging portion is, respectively, disengaged and engaged from the internal threaded portion. In the disengaged and engaged positions, movement of the second jaw is, respectively, permitted and restricted.

### TECHNICAL FIELD

The present technology relates to fixing systems, such as but not limited to fixing systems which include a clamping component for attaching medical devices to a structure.

### BACKGROUND

Fixing systems for mounting devices to a structure and which have a portion to which the device can be attached and another portion which can be detachably attached to the structure are known.

In such known fixing systems, the portion for detachably attaching the fixing system to the structure is a clamping component including a clamping mechanism. However, the clamping component and/or the clamping mechanism in some of the known fixing systems are complex with many components and therefore do not readily lend themselves to use in a medical environment in which cleaning or sterilization of the fixing system may be required. Additionally, known fixing systems can have exposed threads which are open to contaminants.

Furthermore, known fixing systems which include a clamping component may have a cumbersome clamping mechanism which require two-handed operation for attaching and/or detaching the fixing systems to or from the structure. This can be problematic in certain situations where it is desirable for an operator to quickly fasten the fixing system on the structure, and/or to quickly release the fixing system from the structure. Known use cases are for instance when a nursing staff secures an infusion pump to an infusion stand or attaches other types of medical devices to a structure in a medical environment.

Therefore, there is a desire for fixing systems that can overcome at least some of the above-described drawbacks.

### SUMMARY

It is an object of the present technology to ameliorate at least some of the inconveniences present in the prior art.

According to one aspect of the present technology, there is provided a fixing system. The fixing system is suitable for removably attaching a medical device to a structure. The fixing system includes first and second jaw portions and a resilient member. The first jaw portion includes a body, a mounting interface and a first jaw. The body has first and second ends. A channel defined in the body extends from the first end to the second end, and has an internal threaded portion. The mounting interface extends from the first end of the body and has a mounting surface for attaching a device thereto. The first jaw has a first clamp surface and extends from the mounting interface. The second jaw portion is operatively connected to the first jaw portion. The second jaw portion has a jaw end and a handle end. At the handle end, the second jaw portion includes a handle component at least partially received in the channel at the second end of the body. The handle component has a central handle axis and a handle channel defined in the handle component. At the jaw end, the second jaw portion includes a second jaw connected to the handle component. The second jaw has a second clamp surface facing the first clamp surface, and is moveable towards and away from the first jaw in a direction parallel to the central handle axis. The second jaw portion also has a rod at least partially received in the handle channel, and extending from the handle end towards the jaw end. The rod is connected to the second jaw, and is selectively moveable relative to the handle component in a direction parallel to the central handle axis between an actuated position and a non-actuated position. The second jaw portion also includes at least one connector that is pivotably connected to the handle component and that has a first engaging portion which is selectively engageable with the internal threaded portion responsive to movement of the rod between the actuated position and the non-actuated position. The at least one connector is moveable between disengaged and engaged positions. In the disengaged position, the first engaging portion of the at least one connector is disengaged from the internal threaded portion of the body, which permits movement of the second jaw parallel to the central handle axis. In the engaged position, the first connector portion is engaged with the internal threaded portion and movement of the second jaw parallel to the central handle axis is restricted upon application of a force to the handle assembly parallel to the central handle axis. The resilient member is operatively connected to the rod, and biases the rod toward the non-actuated position.

In some embodiments, the rod defines at least one tapered recess in a longitudinal face of the rod, the at least one connector has a second engaging portion received in the at least one tapered recess, and as the rod moves between the actuated and non-actuated positions, the at least one tapered recess is shaped so as to guide the pivoting movement of the at least one connector between the disengaged and engaged positions.

In some embodiments, the at least one tapered recess has a first recess face and a second recess face, the first and second recess faces being inclined and meeting at a point defining a deepest part of the recess.

In some embodiments, the second engaging portion comprises a first engaging face and a second engaging face, the first and second engaging faces meeting at a top of the second engaging portion, and wherein the first engaging face of the second engaging portion is configured to selectively contact the first recess face, and the second engaging face of the second engaging portion is configured to selectively contact the second recess face.

In some embodiments, the at least one connector moves between the disengaged and engaged positions about an arcuate path.

In some embodiments, the at least one connector includes a first connector and a second connector, and the at least one tapered recess includes a first tapered recess configured to receive the first connector and a second tapered recess configured to receive the second connector.

In some embodiments, the first and second connectors are disposed opposite to one another about the central handle axis.

In some embodiments, the resilient member is a spring, the resilient member being positioned around the rod at the handle end of the second jaw component and within the handle channel.

In some embodiments, the mounting surface defines at least one mounting aperture for receiving a fastener.

In some embodiments, the mounting surface is shaped to interface with a medical device mounting surface.

In some embodiments, the system further includes a transition plate positionable between the mounting surface and a medical device mounting surface for aligning and fastening the fixing system to the medical device mounting surface.

In some embodiments, the second jaw includes a connecting portion for spacing the second clamp surface from the body, the connecting portion having a first end which is received in the channel of the body and a second end which is connected to the second clamp surface and which is disposed outside of the body.

In some embodiments, the connecting portion is connected to the rod such that rotating the handle component, with the rod received in the handle channel, does not cause rotation of the second jaw, and moving the handle component, with the rod received in the handle channel, in a direction parallel to the central handle axis causes movement of the handle component and the second jaw in a direction parallel to the central handle axis.

In some embodiments, the connecting portion defines a recess configured to receive an end of the rod therein, the recess having a first shoulder and a second shoulder. The rod has at least one abutting member at the end of the rod received within the recess. In response to the rod being moved to the actuated position, the abutting member abuts the first shoulder, and in response to the rod being moved to the non-actuated position, the abutting member abuts the second shoulder.

In some embodiments, the connecting portion defines a recess configured to receive an end of the rod therein. The rod has at least one abutting member at the end of the rod received within the recess. The connecting portion and the rod are configured such that the abutting member can rotate freely within the recess but a movement of the abutting member parallel to the central handle axis is delimited.

In some embodiments, the handle end of the second jaw portion is disposed outside of the channel of the body, and further includes a handle at the handle end, an end of the rod being accessible from the handle.

In some embodiments, the handle is wider than the body.

In some embodiments, one or both of the first clamp surface and the second clamp surface have an arcuate profile and are free of sharp edges.

In some embodiments, the internal threads are one of left-handed and right-handed threads.

According to one aspect of the present technology, there is provided a fixing system. The fixing system is suitable for removably attaching a medical device to a structure. The fixing system includes first and second jaw portions. The first jaw portion includes a body and a first jaw. The body has first and second ends. A channel defined in the body extends from the first and second end, and has an internal threaded portion. The first jaw includes a first claim surface and extends from the body. The second jaw portion is operatively connected to the first jaw portion. The second jaw portion has a jaw end and a handle end. At the handle end, the second jaw portion includes a handle component at least partially received in the channel at the second end of the body. The handle component has a central handle axis and a handle channel defined in the handle component. At the jaw end, the second jaw portion includes a second jaw connected to the handle component. The second jaw has a second clamp surface facing the first claim surface, and is movable towards and away from the first jaw in a direction parallel to the central handle axis. The second jaw portion also includes a rod at least partially received in the handle channel, and extending from the handle towards the jaw end. The rod is connected to the second jaw and is selectively movable relative to the handle component in a direction parallel to the central handle axis between an actuated and a non-actuated position. The second jaw portion also has at least one connector pivotably connected to the handle component. The at least one connector has a first engaging portion which is selectively engageable with the internal threaded portion of the body, which permits movement of the rod between the actuated and non-actuated position. The at least one connector is moveable between disengaged and engaged positions. In the disengaged position, the first engaging portion of the at least one connector is disengaged from the internal threaded portion of the body, which permits movement of the second jaw parallel to the central handle axis. In the engaged position, the first connector portion is engaged with the internal threaded portion and movement of the second jaw parallel to the central handle axis is restricted upon application of a force to the handle assembly parallel to the central handle axis is restricted upon application of a force to the handle assembly parallel to the central handle axis.

In some embodiments, a section of the body comprises a mounting surface for attaching a device thereto.

In some embodiments, a resilient member is operatively connected to the rod, the resilient member biasing the rod toward the non-actuated position.

### Advantages

In certain embodiments, a medical device can be attached to the fixing system, and the fixing system with the medical device attached thereto can allow for a quick mounting and/or fastening of the medical device and fixing system to a structure. Additionally, the fixing structure can allow for a quick release of the medical device and the fixing structure from the structure.

In certain embodiments, the fixing structure can be manipulated with a single hand.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example “A and/or B” is to be taken as specific disclosure of each of (i) A, (ii) B and (iii) A and B, just as if each is set out individually herein.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1A is a perspective view of a fixing system according to an embodiment of the present technology.

FIG. 1B is a top plan view of the fixing system of FIG. 1A.

FIG. 2A is a cross-sectional view of the fixing system of FIG. 1B through line 2′-2′, with the actuator being in an un-actuated position, and connectors being in an engaged position.

FIG. 2B is a cross-sectional view of the fixing system of FIG. 1B through line 2′-2′, with the actuator being in an actuated position, and connectors being in a disengaged position.

FIG. 3 is a perspective view of the fixing system of FIG. 1A attached to a medical device.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

According to embodiments of the present technology, there is provided a fixing system for releasably mounting a device, such as a medical device, to a structure. The fixing system broadly includes a mounting component to which the device can be attached and a clamping component for detachably attaching the fixing system to the structure.

The clamping component includes a clamping mechanism that is operable with a single hand and can enable quick and strong attachment to the structure as well as a fast release from the structure.

Furthermore, the fixing system is of relatively simple construction, and comprises few components. The few components may have smooth exterior surfaces and can be readily cleaned and/or sterilized making it suitable for medical use. For example, the fixing system can be used to connect medical monitoring equipment such as infusion pumps, power bars, oxygen bottle straps and drainage hooks to an ambulance rail or a stretcher rail during transportation of a patient in the ambulance. Advantageously, the quick single-handed release of the clamping mechanism enables the medical monitoring equipment to be moved quickly if needed.

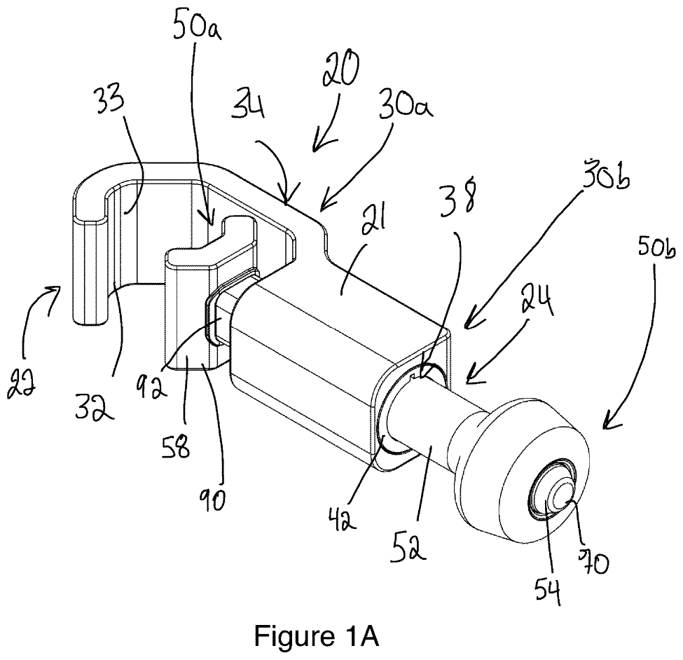

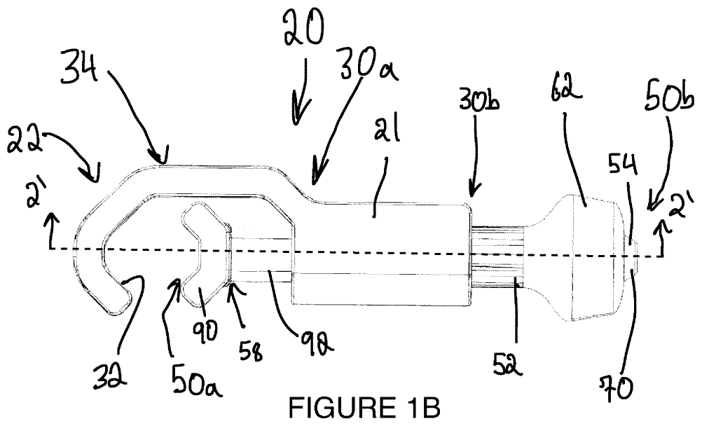

Referring to FIGS. 1A, 1B, 2A, 2B and 3, a fixing system 20 according to an embodiment of the present technology is shown.

The fixing system 20 includes a first jaw portion 22 and a second jaw portion 24. The second jaw assembly 24 is operatively connected to the first jaw portion 22.

The first jaw portion 22 includes a body 21 which has an end 30a and an end 30b. Extending from the end 30a of the body 21, and opposite to the end 30b, is a mounting interface 34 for mounting the device to the fixing system 20. Extending from the mounting interface 34 is a first jaw 32. The first jaw 32 is one of two jaws of the fixing system 20 which can be used to clamp around the structure when the jaws are brought closer together and locked in position. The first jaw 32, the mounting interface 34 and the body 21 are of one-piece construction. However, in other embodiments (not shown), any one of the first jaw 32, the mounting interface 34 and the body 21 may be separate pieces and connected together.

The first jaw 32 has a clamping surface 33 with a concave profile. A profile of the clamping surface 33 is free of sharp edges. In other words, the profile of the clamping surface 33 of the first jaw 32 is rounded. This can assist in reducing damage to the structure to which the fixing system 20 is to be clamped, such as a pole or a rail.

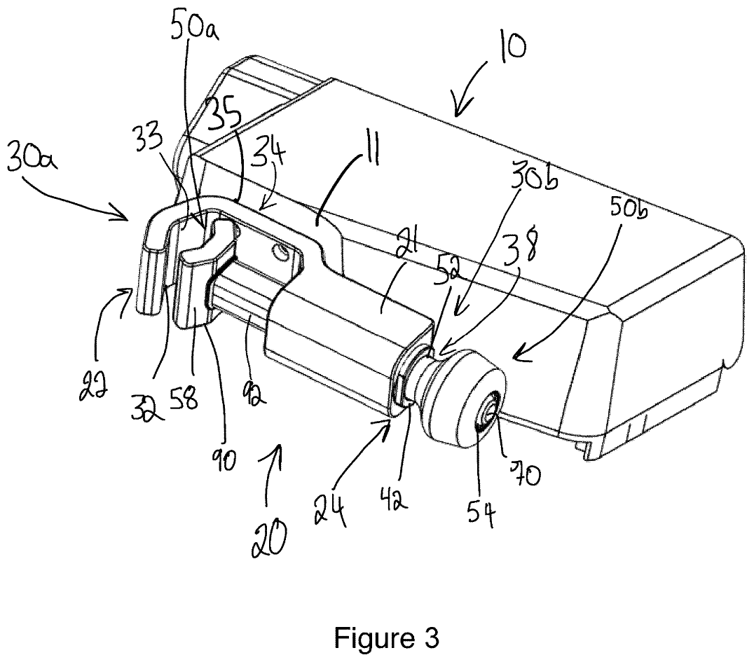

With reference to FIG. 3, the mounting interface 34 comprises a flat mounting surface 35 for attachment of the device thereto. In some embodiments, the mounting surface 35 is shaped to interface with a mounting surface 11 of the device 10, which in FIG. 3 is illustrated as a medical device which is an infusion pump. For example, in certain embodiments, the mounting surface 35 can be shaped to match a geometry of the mounting surface 11 of the medical device 10 to provide a proper fit or convenient connection/disconnection. In some embodiments, at least one mounting aperture 36 is defined in the mounting interface 34 which is configured to receive a fastener therein for attaching the device to the mounting interface 34. The manner of fixation of the device to the mounting interface 34 is not limited. For example, in certain embodiments, the mounting aperture 36 may be threaded and thus configured to receive screws. In some examples, four mounting apertures 36 are provided. In some embodiments, a transition plate (not shown) is configured to be positionable between the mounting surface 35 of the fixing system 20 and the mounting surface 11 of the medical device 10 to couple the fixing system 20 to the medical device 10. In other words, the transition plate is configured to match the mounting surface 34 of the fixing system 20 and the mounting surface 11 of the medical device 10. For example, in certain embodiments, the transition plate is manufactured to match a bolt pattern on the mounting surface 11 of the medical device 10 such that the fixing system 20 and the medical device 10 can be coupled together.

In certain embodiments, the mounting interface 34 is configured to have attached thereon a connector to which the device may be releasably connected. For example, the connector may comprise the base member or the release member of a coupling device, such as that described in WO2021/062558, the contents of which are herein incorporated by reference.

It is contemplated that in other embodiments, the mounting interface 34 could have another connector thereon. In some embodiments, the connector may be integral with the mounting interface 34.

Turning now to the body 21, the body 21 has an open-ended cylindrical configuration with a channel 38 extending therethrough. Both the ends 30a, 30b are open. The channel 38 is configured to receive at least a portion of the second jaw portion 24. The channel 38 has an internal threaded portion 40. The internal threaded portion 40 stops short of the end 30a and the end 30b of the body 21.

There is disposed a seal 42 at the end 30b of the body 21. When the second jaw portion 24 is connected to the first jaw portion, the seal 42 seals the end 30b, thereby reducing chances of matter entering the channel 38. The seal is made of a polymeric material.

Turning now to the second jaw portion 24, the second jaw portion 24 has a jaw end 50a and a handle end 50b. When the second jaw portion 24 is connected to the first jaw portion 22, the jaw end 50a is closer to the end 30a than to the jaw end 50b. The second jaw portion 24 includes a handle component 52, a rod 54, two connectors 56a, 56b, a second jaw 58 and a resilient member 59.

The handle component 52 is at the handle end 50b of the second jaw portion 24, and as will be described in greater detail below, is partially received in the channel 38 of the body 21 from the end 30b.

The handle component 52 has an elongate configuration with a central handle axis 60 extending through a center thereof. At the handle end 50b, the handle component 52 is configured as a handle 62. Specifically, the handle 62 is on the part of the handle component 52 that projects from the channel 38 at the second end 30b. The handle 62 is wider than a remaining part of the handle component 52, and enables an operator to easily manipulate the handle component 52. Additionally, a size of the handle 62 prevents the whole handle component 52 from being received in the channel 38. It is understood that in some embodiments, the handle 62 could have a different configuration than that shown in the accompanying Figures. For instance, in some embodiments, the handle 62 could be a lever and/or could have a T-shape.

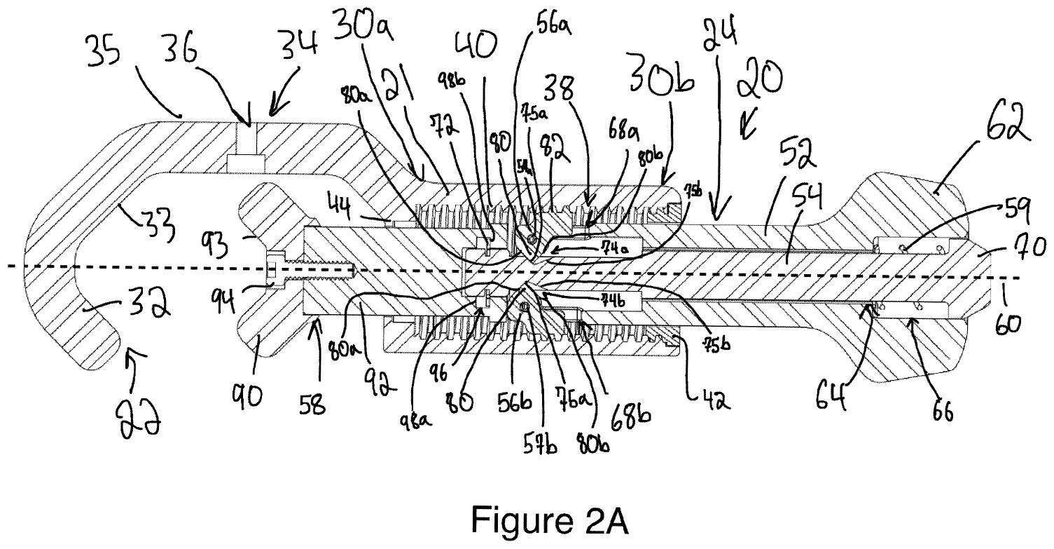

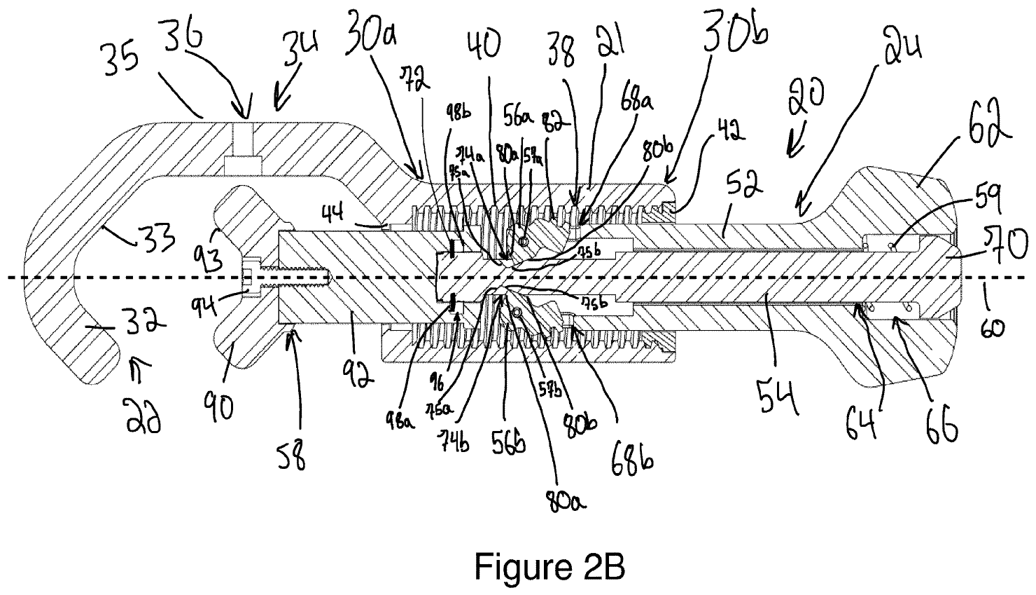

The handle component 52 further has a handle channel 64 that is defined through an entirety of the handle component 52. In the present embodiment, the handle channel 64 is defined about the central handle axis 60, but it is contemplated that in some embodiments, the handle channel 64 could be offset from the central handle axis 60. As shown in FIGS. 2A and 2B, the handle channel 64 has a head section 66 that is wider than at least a portion of a remaining of the handle channel 64. At an opposite end of the handle 62, the handle component 52 defines recesses 68a, 68b that are sized to provide clearance for a movement of the connectors 56a, 56b, which, as will be described in greater detail below, are pivotably connected to the handle component 52.

The rod 54, which is received in the handle channel 64, extends from the handle end 50b toward the jaw end 50a and extends beyond the handle channel 64 towards the jaw end 50a. The rod 54 has at one end oriented toward the handle end 50b, a head 70 which is accessible from the handle 62. On the other end of the rod 54, toward the jaw end 50a, the rod 54 has an abutting member 72. In the present embodiment, the abutting member 72 is a circular disk. It is contemplated that in other embodiments, the rod 54 could have two or more abutting members. For example, in some embodiments, the abutting members could be pins.

Two tapered recesses 74a, 74b are defined in a longitudinal face of the rod at a portion which extends beyond the handle channel 64 towards the jaw end 50a (intermediate to the head 70 and the abutting member 72). The tapered recesses 74a, 74b, which are similar, each have two inclined walls 75a, 75b that meet at a deepest point of the recess. The inclination of the wall 75b is steeper than the inclination of the wall 75a, for guiding the connectors 56a, 56b between actuated and non-actuated positions. However, in other embodiments the inclination of the walls 75a, 75b may be the same or differ such that wall 75a is steeper than wall 75b. As will be described in greater detail below, the tapered recesses 74a, 74b are configured to guide the movement of, respectively, the connectors 56a, 56b, which movement is related to rod 54 being moveable relative to the handle component 52 in a direction parallel to the central handle axis 60 between the non-actuated position (FIG. 2A) and the actuated position (FIG. 2B).

With reference to FIGS. 2A and 2B, the resilient member 59 is a spring 59. It is contemplated that the spring 59 could be another resilient member such as an elastic member, a shape memory alloy, or the like. The spring 59 is disposed within the head section 66 of the handle channel 64 and around the rod 54. One end of the spring 59 abuts the handle component 52, whereas the other end of the spring 59 abuts the head 70, such that the spring 59 is resiliently compressed when the rod 54 is moved from the non-actuated position to the actuated position. Thus, the spring 59 biases the rod 54 toward the non-actuated position as soon as the rod 54 is moved from non-actuated position. It is understood that the spring 59 could be disposed elsewhere in the fixing system 20 without departing from the scope of the present technology.

The two connectors 56a, 56b, which, as mentioned above, are pivotably connected to the handle component 52, will now be described in greater detail. Specifically, the two connectors 56a, 56b are connected to the handle component 52 via, respectively, pins 57a, 57b. The pins 57a, 57b respectively extend through the entirety of the connectors 56a, 56b. It is contemplated that in some embodiments, the pins 57a, 57b could only extend through a portion of the connectors 56a, 56b. Although in the present embodiment, there are two connectors 56a, 56b, it is contemplated that in some embodiments, there could be a single connector, or three or more connectors.

The position of the connectors 56a, 56b in the channel 38 corresponds to a position of the recesses 74a, 74b of the rod 54 in the channel 38 such that the connectors 56a, 56b are received in the respective recesses 74a, 74b. As the recesses 74a, 74b are radially equidistant from each other, the connectors 56a, 56b are also positioned radially equidistant from one another (i.e., opposite to one another about the central handle axis). Also, the connectors 56a, 56b are longitudinally offset from one another (i.e., offset along the central handle axis 60). Specifically, since the connectors 56a, 56b are opposite to one another (i.e., 180 degrees from one another), the connectors 56a, 56b are longitudinally offset by half of a thread pitch of the threaded portion 40 so that the connectors 56a, 56b can mesh with the threaded portion 40. It is contemplated that in certain embodiments, the connectors 56a, 56b and the recesses 74a, 74b could be positioned differently.

As the connectors 56a, 56b are generally similar, only the connector 56a will be described in detail. The connector 56a has an engaging portion 80 that is received in the tapered recess 74a. The engaging portion 80 has engaging faces 80a, 80b which selectively contact the recess walls 75a, 75b. Specifically, the engaging face 80a of the connector 56a can contact the recess wall 75a, and the engaging face 80b of the connector 56a can contact the recess wall 75b. As such, the connector 56 is in continuous engagement with the rod 54.

The connector 56a also has an engaging portion 82 that is threaded and is complementary (i.e., engageable) to the internal threaded portion 40. The engaging portion 82 is on another side of a pivot of the connector 56. The engaging portion 82 is selectively engageable to the internal threaded portion 40 of the channel 38. Pivots of the connectors 56a, 56b extend generally parallel to each other within the channel 38.

Pivotal movement enables the connector 56a to selectively move between an engaged position, in which the engaging portion 82 is engaged with the internal threaded portion 40, and a disengaged position, in which the engaging portion 82 is disengaged from the internal threaded portion 40. In the disengaged portion, threads of the internal threaded portion 40 and threads of the engaging portion 82 are spaced from each other such that the handle component 52 can move parallel to the central handle axis 60 within the channel 38, upon application of a force on the first jaw portion 22 or on the second jaw portion 24.

Due, at least in part, to the pivotal connection between the connector 56a and the handle component 52, the engaging portions 80, 82 of the connector 56a move along an arcuate path between the engaged and disengaged positions.

As the connectors 56a, 56b are connected to the handle component 52, when the connectors 56a, 56b are in the disengaged position (i.e., when the rod 54 is in the actuated position), the handle component 52 can move in a direction parallel to the central handle axis 60 upon application of a force to the second jaw portion 24 in a direction parallel to the central handle axis 60.

On the other hand, when the connectors 56a, 56b are in the engaged position (i.e., when the rod 54 is in the non-actuated position), the movement of the handle component 52 parallel to the central handle axis 60 is restricted in that upon application of a force to the second jaw portion 24 in a direction parallel to the central handle axis 60, the handle component 52 cannot move parallel to the central handle axis 60. When the connectors 56a, 56b are in the engaged position, to move the handle component 52 parallel to the central handle axis 60, the handle component 52 must be rotated about the central handle axis 60.

In some embodiments, when the connectors 56a, 56b are in positions intermediate to the engaged and disengaged positions and a force is applied to the second jaw portion 24 in a direction parallel to the central axis 60 and towards the first jaw 32, the handle component 52 can move in a direction parallel to the central handle axis 60 by ratcheting. More precisely, the engaging portions 82 of the connectors 56a, 56b ratchet with the internal threaded portion 40 when the handle component 52 is pushed to bring the first and second jaws closer together.

In more detail, when the rod 54 is in the non-actuated position, the resilient member is not loaded and pushes the rod outwardly towards the handle end 50b of the handle component 52, and the connectors 56a, 56b are in the engaged position. Specifically, the inclined walls 80a of the engaging portions 80 of the connectors 56a, 56b engage the inclined walls 75a of the tapered recesses 74a, 74b.

In response to the rod 54 being moved toward the actuated position, such as by applying pressure to the head 70 in a direction towards the first and second jaws 32, 58, the resilient member 59 is compressed and the rod 54 including the tapered recesses 74a, 74b thereon also moves in the direction of actuation. The tapered recesses 74a, 74b by engagement with the engaging portions 80 of, respectively, the connectors 56a, 56b, guide the pivotal movement of the connectors 56a, 56b to move the connectors 56a, 56b to the disengaged position. Specifically, the inclined walls 80b of the engaging portions 80 of the connectors 56a, 56b engage the inclined walls 75b of the tapered recesses 74a, 74b. In the cross-sectional views shown in FIGS. 2a and 2b, this is a clockwise pivoting movement of the connector 56a. In the actuated position of the rod, the handle component 52 can be moved parallel to the central handle axis 60 to bring the second jaw 58 closer and/or further from the first jaw 32.

In response to releasing the pressure on the head 70, the rod 54 moves toward the non-actuated position due to a force applied by the resilient member 59 towards the handle end 50b. The tapered recesses 74a, 74b, by engagement with the engaging portions 80 of, respectively, the connectors 56a, 56b, guide the pivotal movement of the connectors 56a, 56b to move the connectors 56a, 56b to the engaged position. Specifically, the inclined walls 75b of the engaging portions 80 of the connectors 56a, 56b engage the inclined walls 75a of the tapered recesses 74a, 74b.

The second jaw 58 includes a clamping portion 90 with a clamp surface 93 and a connecting portion 92. The clamping portion 90 with the clamp surface 93 is disposed outside of the channel 38. A portion of the connecting portion which is connected to the second jaw 58 is also disposed outside of the channel 38. Another portion of the connecting portion 90 is received in the channel 38.

At the end 30a of the body 21, the channel 38 has a lipped portion 44 which narrows the channel 38 at the end 30a and serves to guide movement of the connecting portion 90 as it moves in and out of the channel 38. 92. The lipped portion 44 creates a channel width permitting movement of the connecting portion without impeding motion thereof. This may improve stability of the second jaw portion 24 as it is moved parallel to the central handle axis by preventing or reducing a side-to-side movement (transverse to the central handle axis 60) of the connecting portion as it moves in and out of the channel 38.

The clamping portion 90 and the connecting portion 92 are fixedly connected to one another via a fastener 94. The clamping portion 90 and the connecting portion 92 move as one-piece. It is contemplated that in some embodiments, the second jaw 58 could be one integral component. It is further contemplated that in some embodiments, the clamping and connecting portions 90, 92 could be connected to one another such that the connecting portion 92 is free to rotate relative to the clamping portion 90. As will be described in greater detail below, the second jaw 58 is configured to move relative to the first jaw 32 in a direction parallel to the central handle axis 60, thereby enabling the fixing system 20 to clamp onto the structure. Movement of the second jaw 58 is related to movement of the rod 54 and the handle component 52.

The clamp surface 93 of the clamping portion 90 is concave. A profile of the clamp surface 93 is free of sharp edges. As mentioned above, this can assist in reducing damage to structure to which the fixing system 20 is to be clamped. This also optimizes the fixing system 20 to fit around a variety of poles and rails.

The connecting portion 92, at an end opposite to the clamping portion 90, defines a recess 96 that is configured to receive the end of the rod 54 having the abutting member 72. The recess 96 is also configured to provide clearance for the rod 54 to move between the actuated and non-actuated positions. More specifically, the recess 96 has shoulders 98a, 98b, and in response to the rod 54 being moved to the actuated position, the abutting member 72 abuts the shoulder 98a, whereas in response to the rod 54 being moved to the non-actuated position, the abutting member 72 abuts the shoulder 98b. Despite the operative connection of the connecting portion 92 and the rod 54, the rod 54 is free to rotate relative to the connecting portion 92. In some embodiments, the rod 54 may be rotationally fixed to the connecting portion 92. In such embodiments, the clamping portion 90 and the connecting portion 92 are free to rotate relative to one another.

With continued reference to FIGS. 2A and 2B, the fixing system 20 in operation will now be described.

The fixing system 20 is positioned such that the first jaw 32 and the second jaw 58 are disposed around a structure to which the fixing system 20 is to be clamped. In some instances, the structure could be a pole or a rail.

Then, to clamp the fixing system 20 onto the structure, a distance between the clamp surfaces 33, 93 of the first and second jaws 32, 58 must be reduced. In other words, the second jaw 58 must be moved toward the first jaw 32. This can be achieved by operating the fixing system in different manners.

In a first method of operation, the handle component 52 is rotated about the central handle axis 60 while the rod 54 is in the non-actuated position (i.e., the connectors 56a, 56b are in the engaged positions). This first method may be preferred when a required distance of movement of the second jaw 58 is a relatively small distance (i.e., the second jaw 58 does not need to be moved toward the first jaw 32 by a substantial amount). In some embodiments, the small distance is about 5% of a maximum distance between the clamping surfaces 33, 93 of the first and second jaws. In other embodiments, the small distance is about 10% of the maximum distance between the clamping surfaces 33, 93 of the first and second jaws. In yet other embodiments, the small distance is about 3% or about 25% of the maximum distance between the clamping surfaces of the first and second jaws 33, 93. The small distance can be dependent on the thread profile (an increase in pitch of the thread can increase longitudinal movement of the second jaw 58 toward the first jaw 32 for one full rotation of the handle 62). In some instances, and without being limited thereto, a small distance could represent one or two full rotations of the handle 62, a medium distance could represent three or four full rotations of the handle 62 and a large distance could represent five or more full rotations of the handle 62. For example, in a situation where the internal threaded portion 40 has 20 threads, a small distance would be between about 5% to 10%, a medium distance would be between about 10% and 20%, and a large distance would be about 20% or more. On the other hand, in a situation where the internal threaded portion 40 has 30 threads (i.e., smaller pitch, higher thread per inch (TPI)), a small distance would be between about 3% to 7%, a medium distance would be between about 7% and 10%, and a large distance would be about 10% or more.

Due to an angle of the internal threads of the internal threaded portion 40, rotation of the handle component 52 causes the handle component 52 to move toward the end 30a. Specifically, the handle component 52 can be rotated by the handle 62. It is to be noted that the rotation of the handle component 52 can be done with a single hand. Since the rod 54 is in the non-actuated position, the connectors 56a, 56b are engaging the internal threaded portion 40. Thus, as mentioned above, as the connectors 56a, 56b are connected to the handle component 52, rotation of the handle component 52 results in the handle component 52 being screwed into the channel 38. As the handle component 52 is being screwed, due to the shape of the tapered recesses 74a, 74b, the engaging portions 80 of the connectors 56a, 56b push on the inclined walls 75a toward the end 30a such that, at this stage, the handle component 52, the rod 54 and the connectors 56a, 56b move toward the end 30a. Eventually, the abutting member 72 abuts the shoulder 98a. As a result of this abutment, movement of the rod 54 toward the end 30a results in movement the connecting portion 92 toward the end 30a. Thus, at this stage, as the handle component 52 is being screwed, the handle component 52, the rod 54, the connectors 56a, 56b and the second jaw 58 move toward the end 30a. In short, rotation of the handle component 52 in a first direction results in the second jaw portion 24 being screwed into the channel 38, which results in the second jaw 58 moving toward the first jaw 32.

The second method is preferred when the second jaw 58 needs to be moved relative toward the first jaw 32 by a substantial distance. In some embodiments, the substantial distance is about 50% of the maximum distance between the clamping surfaces 33, 93 of the first and second jaws. In other embodiments, the substantial distance is about 60% of the maximum distance between the clamping surfaces 33, 93 of the first and second jaws. In yet other embodiments, the substantial distance is about 75% of the maximum distance between the clamping surfaces 33, 93 of the first and second jaws. This method provides a faster clamping process of the fixing system 20.

This method includes moving the rod 54 to the actuated position. This can be done by pressing on the head 70 of the rod 54, which is accessible by handle 62 of the handle component 52. It is to be noted that the configuration of the fixing system 20 enables a user to move the rod 54 with a single hand. For example, an operator can have his/her thumb of a hand on the head 70, and the other fingers of the same hand around the handle 62. Alternatively, the operator can push on the handle 62 and the head 70 at the same time using the palm of their hand. Moving the rod 54 to the actuated position compresses the spring 59 and causes the connectors 56a, 56b to move toward the disengaged position.

Applying a force to the second jaw portion 24 in a direction parallel to the central handle axis 60 and towards the end 30a while maintaining the rod 54 in the actuated position causes the handle component 52, the rod 54 and the connectors 56a, 56b moving toward the end 30a. When the abutting member 72 abuts the shoulder 98a, upon continued application of the force, the handle component 52, the rod 54, the connectors 56a, 56b and the second jaw 58 move toward the first jaw 32.

Then, once the desired position of the first jaw 32 and the second jaw 58 is achieved, such as when they are clamped about the structure, the rod 54 can be released. Since the rod 54 is biased toward the non-actuated position and the connectors to the engaged position, the rod 54 moves toward the non-actuated position and the connectors 56a, 56b move toward the engaged position, and engage the internal threaded portion 40.

If a finer movement of the first jaw 32 and the second jaw 58 is required, the rotation method described above can be performed. In certain embodiments, bringing the first jaw 32 and the second jaw 58 closer together using the second method followed by rotation of the handle component according to the first method can provide a more secure connection of the fixing system 20 to the structure.

To release the fixing system 20 for removal from the structure, the handle component 52 is rotated about the central handle axis 60 while the rod 52 is in the non-actuated position. The handle component 52 is rotated in a direction resulting in the handle component 52 moving toward the end 30b. This depends on whether the internal threads have a left-handed or a right-handed configuration. The rotation required for release of the fixing system 20 is an opposite direction to that required for tightening of the fixing system 20 around the structure.

As mentioned above, the handle component 52 can be rotated by the handle 62, which can be performed with a single hand. Since the rod 54 is in the non-actuated position, rotation of the handle component 52 results in the handle component 52 being unscrewed from the channel 38. As the handle component 52 is being unscrewed, due to the shape of the tapered recesses 74a, 74b, the engaging portions 80 of the connectors 56a, 56b push the rod 54 toward the end 30b such that, at this stage, the handle component 52, the rod 54 and the connectors 56a, 56b move toward the end 30b. Eventually, the abutting member 72 abuts the shoulder 98b. As a result of this abutment, movement of the rod 54 toward the end 30b results in movement the connecting portion 92 toward the end 30b. Thus, at this stage, as the handle component 52 is being unscrewed, the handle component 52, the rod 54, the connectors 56a, 56b and the second jaw 58 move toward the end 30b. In short, rotation of the handle component 52 in a second direction results in the second jaw portion 24 being unscrewed from the channel 38, which results in the second jaw 58 moving away the first jaw 32.

This rotation can be continued until the first and second jaws are spaced sufficiently for the fixing system 20 to be removed from the structure.

Alternatively, or in addition, once the first jaw 32 and the second jaw 58 are no longer clamping the structure, the rod 54 can be moved to the actuated position. As described above, this can be done by pressing on the head 70 of the rod 54, which is accessible by the handle 62 of the handle component 52, and which can be performed with a single hand. Moving the rod 54 to the actuated position compresses the spring 59 and causes movement of the connectors 56a, 56b, guided by the tapered recesses 74a, 74b, toward the disengaged position.

Then, a force can be applied to the second jaw portion 24 in a direction parallel to the central handle axis 60 and towards the end 30b while maintaining the rod 54 in the actuated position.

In the present embodiments, the force is applied to the handle component 52. This results in the handle component 52, the rod 54 and the connectors 56a, 56b moving toward the end 30b, and since the abutting member 72 is already abutting the shoulder 98b the second jaw 58 is also moving toward the end 30b (i.e., the second jaw 58 moves away from the first jaw 32).

Then, the rod 54 can be released, thereby resulting in the rod 54 moving toward the un-actuated position and the connectors 56a, 56b moving toward the engaged position.

Modifications and improvements to the above-described embodiments of the present invention may become apparent to those skilled in the art. The foregoing description is intended to be exemplary rather than limiting. The scope of the present invention is therefore intended to be limited solely by the appended claims.

1. A fixing system comprising:
a first jaw portion comprising:
a body with a first end and a second end, a channel defined in the body and extending from the first end to the second end, the channel having an internal threaded portion;
a mounting interface extending from the first end of the body and having a mounting surface for attaching a device thereto;
a first jaw with a first clamp surface, the first jaw extending from the mounting interface; and
a second jaw portion operatively connected to the first jaw portion, the second jaw portion having a jaw end and a handle end, and the second jaw portion comprising:
at the handle end, a handle component at least partially received in the channel at the second end of the body, the handle component having a central handle axis and a handle channel defined in the handle component;
at the jaw end, a second jaw connected to the handle component, the second jaw having a second clamp surface facing the first clamp surface, the second jaw being moveable towards and away from the first jaw in a direction parallel to the central handle axis;
a rod at least partially received in the handle channel, extending from the handle end towards the jaw end, and connected to the second jaw, the rod being selectively moveable relative to the handle component in a direction parallel to the central handle axis between an actuated position and a non-actuated position; and
at least one connector connected to the handle component and having a first engaging portion which is selectively engageable with the internal threaded portion responsive to movement of the rod between the actuated position and the non-actuated position, the at least one connector being moveable between:
a disengaged position in which the first engaging portion is disengaged from the internal threaded portion permitting movement of the second jaw parallel to the central handle axis, and
an engaged position in which the at least one connector is engaged with the internal threaded portion and movement of the second jaw parallel to the central handle axis is restricted upon application of a force to the handle component parallel to the central handle axis,
a resilient member operatively connected to the rod, the resilient member biasing the rod toward the non-actuated position.

2. The fixing system of claim 1, wherein the rod defines at least one tapered recess in a longitudinal face of the rod, the at least one connector has a second engaging portion received in the at least one tapered recess, and as the rod moves between the actuated and non-actuated positions, the at least one tapered recess is shaped so as to guide the movement of the at least one connector between the disengaged and engaged positions.

3. The fixing system of claim 2, wherein the at least one tapered recess has a first recess face and a second recess face, the first and second recess faces being inclined and meeting at a point defining a deepest part of the recess.

4. The fixing system of claim 3, wherein the second engaging portion comprises a first engaging face and a second engaging face, the first and second engaging faces meeting at a top of the second engaging portion, and wherein the first engaging face of the second engaging portion is configured to selectively contact the first recess face, and the second engaging face of the second engaging portion is configured to selectively contact the second recess face.

5. (canceled)

6. The fixing system of claim 2, wherein the at least one connector includes a first connector and a second connector, and the at least one tapered recess includes a first tapered recess configured to receive the first connector and a second tapered recess configured to receive the second connector.

7. The fixing system of claim 6, wherein the first and second connectors are disposed opposite to one another about the central handle axis.

8. The fixing system of claim 1, wherein the resilient member is a spring, the resilient member being positioned around the rod at the handle end of the second jaw component and within the handle channel.

9. The fixing system of claim 1, wherein the mounting surface defines at least one mounting aperture for receiving a fastener.

10. The fixing system of claim 1, wherein the mounting surface is shaped to interface with a medical device mounting surface.

11. The fixing system of claim 1, further comprising a transition plate positionable between the mounting surface and a medical device mounting surface for aligning and fastening the fixing system to the medical device mounting surface.

12. The fixing system of claim 11, wherein the mounting surface is shaped to interface with the medical device mounting surface.

13. The fixing system of claim 1, wherein the second jaw includes a connecting portion for spacing the second clamp surface from the body, the connecting portion having a first end which is received in the channel of the body and a second end which is connected to the second clamp surface and which is disposed outside of the body.

14. The fixing system of claim 13, wherein the connecting portion is connected to the rod such that:
rotating the handle component, with the rod received in the handle channel, does not cause rotation of the second jaw, and
moving the handle component, with the rod received in the handle channel, in a direction parallel to the central handle axis causes movement of the handle component and the second jaw in a direction parallel to the central handle axis.

15. The fixing system of claim 13, wherein:
the connecting portion defines a recess configured to receive an end of the rod therein, the recess having a first shoulder and a second shoulder,
the rod has at least one abutting member at the end of the rod received within the recess, and
in response to the rod being moved to the actuated position, the abutting member abuts the first shoulder; and
in response to the rod being moved to the non-actuated position, the abutting member abuts the second shoulder.

16. The fixing system of claim 13, wherein:
the connecting portion defines a recess configured to receive an end of the rod therein,
the rod has at least one abutting member at the end of the rod received within the recess, wherein the connecting portion and the rod are configured such that the abutting member can rotate freely within the recess but a movement of the abutting member parallel to the central handle axis is delimited.

17. The fixing system of claim 1, wherein the handle end of the second jaw portion is disposed outside of the channel of the body, and further comprises a handle at the handle end, an end of the rod being accessible from the handle.

18. (canceled)

19. (canceled)

20. The fixing system of claim 1, wherein the internal threads are one of left-handed and right-handed threads.

21. A fixing system comprising:
a first jaw portion comprising:
a body with a first end and a second end, a channel defined in the body and extending from the first end to the second end, the channel having an internal threaded portion;
a first jaw with a first clamp surface, the first jaw extending from the body; and
a second jaw portion operatively connected to the first jaw portion, the second jaw portion having a jaw end and a handle end, and the second jaw portion comprising:
at the handle end, a handle component at least partially received in the channel at the second end of the body, the handle component having a central handle axis and a handle channel defined in the handle component;
at the jaw end, a second jaw connected to the handle component, the second jaw having a second clamp surface facing the first clamp surface, the second jaw being moveable towards and away from the first jaw in a direction parallel to the central handle axis;
a rod at least partially received in the handle channel, extending from the handle end towards the jaw end, and connected to the second jaw, the rod being selectively moveable relative to the handle component in a direction parallel to the central handle axis between an actuated position and a non-actuated position; and
at least one connector connected to the handle component and having a first engaging portion which is selectively engageable with the internal threaded portion responsive to movement of the rod between the actuated position and the non-actuated position, the at least one connector being moveable between:
a disengaged position in which the first engaging portion is disengaged from the internal threaded portion permitting movement of the second jaw parallel to the central handle axis, and
an engaged position in which the at least one connector is engaged with the internal threaded portion and movement of the second jaw parallel to the central handle axis is restricted upon application of a force to the handle component parallel to the central handle axis.

22. The fixing system of claim 21, wherein a section of the body comprises a mounting surface for attaching a device thereto.

23. The fixing system of claim 21, further comprising a resilient member operatively connected to the rod, the resilient member biasing the rod toward the non-actuated position.
